(19) United States
(12) Patent Application Publication
(10) Pub. No.: US 2019/0295745 A1
(43) Pub. Date: Sep. 26, 2019

(54) HDMI PHOTOELECTRIC COMPOSITE CABLE AND METHOD FOR MANUFACTURING THE SAME

(71) Applicant: DONGGUAN SINOSYNCS INDUSTRIAL CO., LTD., Town Dongguan Guangdong (CN)

(72) Inventors: Weiling Peng, Town Dongguan Guangdong (CN); Henry Sun, Town Dongguan Guangdong (CN)

(21) Appl. No.: 16/034,164

(22) Filed: Jul. 12, 2018

(30) Foreign Application Priority Data
Mar. 23, 2018 (CN) 201810246260.5

(51) Int. Cl. H01B 11/22; G02B 6/44; H01B 7/18; H01B 7/295; H01B 3/44; H01B 13/14; H01B 13/24

(52) U.S. Cl. CPC H01B 11/22; G02B 6/4416; G02B 6/443; G02B 6/4482; G02B 6/4436; H01B 13/24; H01B 7/295; H01B 3/441; H01B 3/443; H01B 13/14; H01B 7/1875

(57) ABSTRACT

The present disclosure discloses an HDMI photoelectric composite cable. The HDMI photoelectric composite cable includes: a sheath, an optical fiber unit, a plurality of signal control wires, a ground wire and fillers. The optical fiber unit includes one or more optical fibers and an optical fiber sheath uniformly extruded on a periphery of the optical fibers. The signal control wire includes a metal wire and an insulating layer uniformly extruded on a periphery of the metal wire. The ground wire is a metal conductor. The fillers are arranged on peripheries of the optical fiber unit, the plurality of signal control wires and the ground wire. The optical fiber unit, the plurality of signal control wires, the ground wire, and the fillers arranged on the peripheries thereof are covered by the shielding layer, and the shielding layer is covered by the sheath.

### CROSS-REFERENCE TO RELATED APPLICATION

This application claims priority to Chinese Patent Application Serial No. CN 201810246260.5, filed on Mar. 23, 2018, the disclosure of which is hereby incorporated herein in its entirety by this reference.

### TECHNICAL FIELD

The present disclosure relates to the technical field of HDMI long-distance high-definition wires, and particularly to an HDMI photoelectric composite cable and a method for manufacturing the HDMI photoelectric composite cable.

### BACKGROUND

With increasing development of science and technology, popularization of a 4K TV, and rapid improvement of quality of human life, the requirement for a high transmission rate of a high-frequency wire is increasing. Large screens at large video venues, high-end hotels, supermarkets and outdoor plazas need long-distance HDMI wires. The short HDMI wires may be 30 m to 50 m, and the long ones may be hundreds of meters. A common HDMI cable takes a metal wire as a transmission carrier, which has disadvantages that a metal wire has a resistance that would accumulatively generate a larger attenuation value with the increase of wire length, causing the signal attenuation. Therefore, the bandwidth and the use length of HDMI cable are greatly limited. Currently, the common bandwidth of the HDMI cable in the market is about 10.2 Gbps, and the maximum use length of the cable is about 30 m. HDMI 2.0 specification requires a transmission bandwidth of 18 Gbps and a maximum transmission distance of the cable for 20 m. HDMI cable uses a copper conductor, and increases the transmission length and bandwidth by increasing a diameter of the copper conductor, but the copper conductor has a transmission bandwidth limit of 6 Gbps and a transmission distance of about 20 m. For higher bandwidth and longer use distance of the HDMI, generally the transmission distance is above 30 m, and the copper conductor cannot meet the requirements of the transmission distance and bandwidth.

In a related art, to meet the requirements of the transmission distance and bandwidth, two electronic wires are generally twisted to form a twisted pair, and then, a copper conductor and the twisted pair are placed in parallel and wrapped by a shielding layer to form a shielded wire. The shielded wire is glued with an optical fiber bundle and a plurality of electronic wires, and the shielded wire, the optical fiber bundle and the plurality of electronic wires are covered with a reinforcing member. A sheath is extruded on a periphery of the reinforcing member to form a photoelectric composite cable. The capacitance value of the photoelectric composite cable is an important factor of determining that the length of the photoelectric composite cable, and when the capacitance is smaller, the photoelectric composite cable could perform the long-distance transmission. In an actual use, the capacitance of the photoelectric composite cable is large, causing that the photoelectric composite cable could not perform the long-distance transmission.

### BRIEF SUMMARY

With regard to the above problem, the present disclosure proposes a High Definition Multimedia Interface (HDMI) photoelectric composite cable and a method for manufacturing the HDMI photoelectric composite cable. The HDMI cable has a small capacitance and a small signal attenuation, and thus, can achieve long-distance transmission.

The present disclosure adopts the following technical solution.

An HDMI photoelectric composite cable includes a sheath, an optical fiber unit that includes one or more optical fibers and an optical fiber sheath uniformly extruded on a periphery of the one or more optical fibers, a plurality of signal control wires, each of which includes a metal wire and an insulating layer uniformly extruded on a periphery of the metal wire, a ground wire, which is a metal conductor, fillers arranged on peripheries of the optical fiber unit, the plurality of signal control wires and the ground wire, and a shielding layer. The optical fiber unit, the plurality of signal control wires, the ground wire and the fillers are covered by the shielding layer. The shielding layer is covered by the sheath.

In an exemplary embodiment, the optical fiber unit is arranged in a center of the cable, and the plurality of signal control wires and the ground wire are arranged on the periphery of the optical fiber unit.

In an exemplary embodiment, the optical fiber unit includes four optical fibers, each of which is a colored multimode optical fiber or an optical fiber ribbon.

In an exemplary embodiment, the optical fiber sheath is flame-retardant polyvinyl chloride, polyethylene, cross-linked polyethylene or fluorinated ethylene propylene p.

In an exemplary embodiment, the metal wire is a single strand of tin-plated copper, a single strand of bare copper, a single strand of silver-plated copper, twisted tin-plated copper wires, twisted bare copper wires or twisted silver-plated copper wires.

In an exemplary embodiment, the insulating layer is foamed polyethylene, polyvinyl chloride, polyethylene, cross-linked polyethylene or fluorinated ethylene propylene.

In an exemplary embodiment, the fillers are aramid yarns, PP ripcords, cotton yarns or nylon yarns.

In an exemplary embodiment, the shielding layer is a polyester tape, an aluminum foil, a copper foil MYLAR® tape, cotton paper or a TEFLON® tape.

In an exemplary embodiment, the sheath is polyvinyl chloride, low-smoke halogen-free flame-retardant polyolefin, a nylon elastomer, a polyurethane elastomer or a cross-linked polyethylene elastomer.

A method for manufacturing an HDMI photoelectric composite cable is provided to manufacture the above HDMI photoelectric composite cable. The method includes:
providing a plurality of signal control wires, a ground wire and a plurality of optical fibers;
extruding an optical fiber sheath on the periphery of the plurality of optical fibers uniformly by an extruder, to form an optical fiber unit;
twisting the optical fiber unit, the plurality of signal control wires and the ground wire concentrically and unidirectionally to form a stranded conductor, and uniformly covering the periphery of the stranded conductor by the fillers;
extruding a shielding layer on the periphery of the fillers; and
extruding a sheath on the periphery of the shielding layer.

The present disclosure has the following beneficial effects.

The optical fiber unit is used to replace the copper wire or an alloy conductor in the related art, so that the capacitance is lower, the signal attenuation is smaller, and the long-distance transmission is achieved. Meanwhile, an outer diameter of the optical fiber unit is reduced by at least half when compared with that of a conventional copper conductor or alloy conductor wire, and the weight of the optical fiber unit is reduced by three-fourths. The fillers are added between the optical fiber unit and the signal control wires, for increasing the overall roundness of the cable and increasing the anti-tensile and anti-swing capabilities of the cable, so that internal characteristics of the cable are not damaged due to pulling by an external force in a paving process.

### BRIEF DESCRIPTION OF DRAWINGS

FIG. 1 is a structural schematic diagram illustrating an HDMI photoelectric composite cable provided by the present disclosure; and

FIG. 2 is a flow chart of a method for manufacturing an HDMI photoelectric composite cable provided by the present disclosure.

### IN THE FIGURES

1. Sheath;
2. Optical fiber unit;
3. Signal control wire;
4. Ground wire;
5. Shielding layer;
6. Filler;
21. Optical fiber;
22. Optical fiber sheath
31. Metal wire; and
32. Insulating layer.

### DETAILED DESCRIPTION

The present disclosure is further described in detail in combination with drawings and embodiments. It should be understood that, specific embodiments described herein are only used for interpreting the present disclosure, rather than limiting the present disclosure. In addition, it should also be noted that, for ease of description, the drawings only illustrate part of structures related to the present disclosure, rather than all structures.

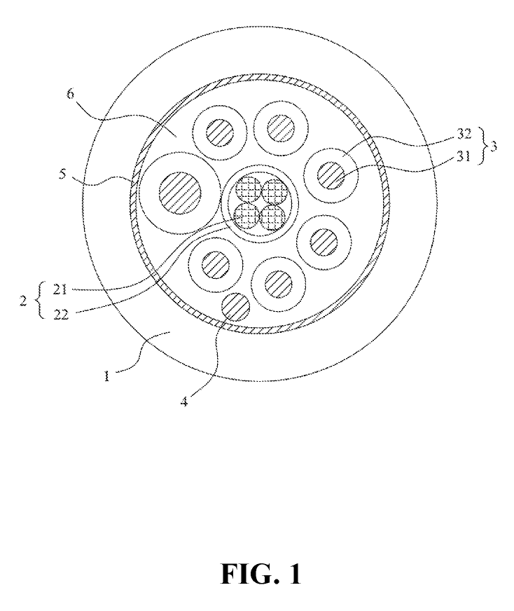

FIG. 1 is a structural schematic diagram illustrating an HDMI photoelectric composite cable provided by the present disclosure. The HDMI photoelectric composite cable mainly includes a sheath 1, an optical fiber unit 2, signal control wires 3, a ground wire 4 and a shielding layer 5. The sheath 1 is a protective sheath of the whole cable. The ground wire 4 and the shielding layer 5 are configured to shield an external signal from interfering with an internal signal and may also be configured to shield the internal signal of the cable from interfering with the external signal. The optical fiber unit 2 is configured to transmit a signal, and the signal control wire 3 is configured to transmit a control signal.

As shown in FIG. 1, the optical fiber unit 2 includes four optical fibers 21 and an optical fiber sheath 22 uniformly extruded on a periphery of the optical fibers 21. The optical fiber 21 is a colored multimode optical fiber or an optical fiber ribbon. There are several colors of colored optical fibers, the most commonly used are brown, green, blue and orange, and the common optical fiber is OM3-300 optical fiber or OM4-550 optical fiber. The optical fiber sheath 22 is flame-retardant polyvinyl chloride, polyethylene, cross-linked polyethylene or fluorinated ethylene propylene. The four optical fibers 21 are closely arranged (i.e., arranged in two rows and two rows) and fixed through the optical fiber sheath 22. A detection method of accurately controlling a covering tightness is that the optical fibers 21 is shrunk by 1% and the additional attenuation of the optical fiber is less than 0.05 dB/km, after the optical fiber sheath 22 is tightened. Specifically, the optical fiber unit 2 is used to replace the copper wire or the alloy conductor in the existing art to transmit a high-frequency signal. When the OM3-300 multimode optical fiber is used as the optical fiber 21, the transmission speed is 18 Gbps, and the transmission distance is up to 150 m. When the optical fiber 21 is the OM4-550 multimode optical fiber, the transmission speed is 48 Gbps, and the transmission distance is up to 300 m, thereby greatly increasing the transmission distance.

The signal control wire 3 includes a metal wire 31 and an insulating layer 32 uniformly extruded on a periphery of the metal wire 31. The metal wire 31 is a single strand of tin-plated copper, a single strand of bare copper, a single strand of silver-plated copper, twisted tin-plated copper wires, twisted bare copper wires or twisted silver-plated copper wires. The material of the insulating layer 32 is preferably a material having a low dielectric constant, and the common material includes foamed polyethylene, polyvinyl chloride, polyethylene, cross-linked polyethylene or fluorinated ethylene propylene. The material and diameter of the insulating layer 32 are adjusted according to the standard of the metal wire 31, to adjust the capacitance between each signal control wire 3 and the ground wire 4, thereby guaranteeing the good compatibility of the material.

In FIG. 1, seven signal control wires 3 are provided, and one of the seven signal control wires having a larger diameter is a power line, and other signal control wires are signal lines having remote control, plug and play and other functions. The ground wire 4 is a metal conductor, and the material thereof could be the same as that of the metal wire 31. The optical fiber unit 2 is arranged in a center of the cable, and the plurality of signal control wires 3 and the ground wire 4 are arranged on the periphery of the optical fiber unit 2. The fillers 6 are aramid yarns, PP ripcords, cotton yarns or nylon yarns, and could increase the ductility of the whole optical cable while guaranteeing the roundness of the wire.

The optical fiber unit 2, the plurality of signal control wires 3, the ground wire 4 and the fillers 6 arranged on the peripheries thereof are covered by the shielding layer 5. The shielding layer 5 is a polyester tape, an aluminum foil, a copper foil MYLAR® tape, cotton paper or a TEFLON® tape. The shielding layer 5 is covered by the sheath 1, and the sheath 1 is polyvinyl chloride, low-smoke halogen-free flame-retardant polyolefin, a nylon elastomer, a polyurethane elastomer or a cross-linked polyethylene elastomer.

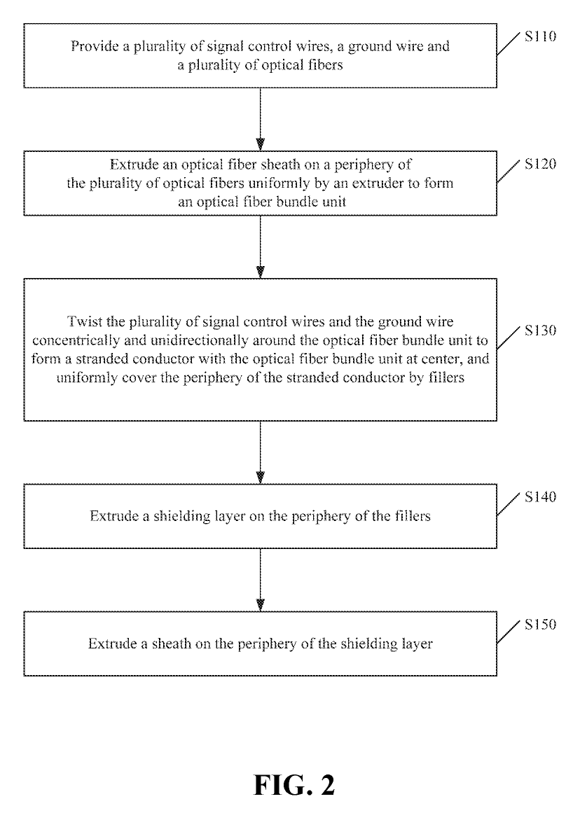

The present disclosure further provides a method for manufacturing an HDMI photoelectric composite cable to manufacture the above HDMI photoelectric composite cable. As shown in FIG. 2, the method includes steps S110 to S150.

In step S110, the plurality of signal control wires 3 is provided. Specifically, a plurality of single wires having the same diameter or different diameters are twisted according to a certain direction and a certain rule. The size of the conductor is selected according to an actual engineering need, and the material of the specific single-wire conductor includes tin-plated copper, bare copper, silver-plated copper and alloy wire. A twisting direction is divided into a left direction (an S direction) and a right direction (Z direction). If the single-wire conductor is used, the twisting process is not needed. Further, the insulating layer 32 is extruded on a surface of each conductor by an extruder, to form the signal control wire 3. The specific implementation method is as follows. Internal and external molds of an appropriate core wire are selected according to a size of the copper wire and an extruding outer diameter. By controlling the outer diameter of the core wire, an extruding temperature, capacitance, a linear speed and other parameters, the tolerance of the outer diameter of the core wire is controlled at ±0.02 mm, the extruding temperature is controlled at ±2° C., and the capacitance is controlled at ±1 PF. Meanwhile, to guarantee the good compatibility and a low capacitance of the wire, insulating materials having relatively small dielectric constant are generally selected, thereby guaranteeing the stable quality of the wire.

The plurality of optical fibers 21 are provided, and cured ink is coated on the surface of the optical fiber 21 through a coloring mold to form the optical fiber 21 easy to distinguish the color.

A ground wire 4 is provided.

In step S120, an optical fiber sheath 22 is uniformly extruded on peripheries of the plurality of optical fibers 21 by an extruder, to form the optical fiber unit 2. Specifically, the optical fiber 21 is released from a pay-off spool with a certain tension, and the optical fiber sheath 22 is extruded in a reasonable process condition. The tensile force of the optical fiber sheath 22 should be controlled. The retraction easily occurs if the optical fiber sheath 22 is too loose, and the optical attenuation is large if the optical fiber sheath 22 is too tight. The standard of the tightness is that, after tightening the optical fiber sheath 22, the shrinking is less than 1%, and the additional attenuation value of the optical fiber is less than 0.05 dB/km.

In step S130, the optical fiber unit 2 is placed in a center of the cable. The plurality of signal control wires 3 and the ground wire 4 are concentrically and unidirectionally twisted in a periphery of the optical fiber unit 2 to form a stranded conductor, and the fillers 6 uniformly cover the periphery of the stranded conductor. Specifically, the optical fiber unit 2 is placed in the center of the cable, the plurality of signal control wires 3 and the ground wire 4 are arranged around the optical fiber unit 2 circumferentially, the fillers 6 are arranged therebetween, and the optical fiber unit 2, the plurality of signal control wires 3, the ground wire 4 and the fillers 6 are stranded based on a reasonable lay distance and a reasonable stranding direction.

In step S140, a shielding layer 5 is extruded on the periphery of the fillers 6.

In step S150, a sheath 1 is extruded on a periphery of the shielding layer 5. Specifically, a suitable mold is selected according to the size of the cable core, the extruding temperature, extruding amount, the linear speed and other parameters are controlled through the extruder, and the sheath 1 having a suitable outer diameter is extruded. The material of the sheath 1 is selected according to the use condition and the paving condition of the optical cable. The sheath 1, as a protective layer of the optical cable to resist various special complicated environments of the outside, has good mechanical property, environmental resistance and chemical resistance. Unavoidably, the optical cable will be suffered from pulling, lateral pressing, impact, torsion, alternating bending and buckling of various external mechanical forces in the paving and use process. The sheath 1 can bear the effects of such external forces.

To sum up, a configuration of the related art, in which the shielded wire is formed by two electronic wires, a copper conductor and a shielding layer, and the cable is formed by the shielded wire, the optical fiber bundle and a plurality of electronic wires, is not adopted in the present disclosure. The optical fiber unit of the present disclosure is directly stranded with the signal control wire, the ground wire and the fillers, and then, the shielding layer and the sheath are extruded on the peripheries of the fillers. With such structure, the capacitance of the cable is lower and the signal attenuation is smaller. Meanwhile, the HDMI photoelectric composite cable provided by the present disclosure has a simple structure, a reasonable design, a long transmission distance, a fast transmission rate, a small diameter, a light weight, and is easy to pave and install. The manufacturing method thereof has reasonable process and high efficiency.

It should be noted that the above only describes exemplary embodiments and technical principles of the present disclosure. It shall be understood by those skilled in the art that the present disclosure is not limited to specific embodiments described herein. Those skilled in the art can make various apparent changes, adjustments and substitutions without departing from a protection scope of the present disclosure. Therefore, although the present disclosure is described in detail through above embodiments, the present disclosure is not limited to above embodiments and may further include more other equivalent embodiments without departing from concepts of the present disclosure. The scope of the present disclosure is determined by a scope of attached claims.

1. A High Definition Multimedia Interface (HDMI) photoelectric composite cable, comprising:
a sheath;
an optical fiber unit comprising one or more optical fibers and an optical fiber sheath uniformly extruded on a periphery of the one or more optical fibers;
a plurality of signal control wires, each of which comprises a metal wire and an insulating layer uniformly extruded on a periphery of the metal wire, wherein material of the insulating layer is a material having a low dielectric constant to reduce capacitance of the HDMI photoelectric composite cable;
a ground wire which is a metal conductor;
fillers arranged on peripheries of the optical fiber unit, the plurality of signal control wires and the ground wire; and
a shielding layer, wherein the optical fiber unit, the plurality of signal control wires, the ground wire and the fillers are covered by the shielding layer,
wherein the shielding layer is covered by the sheath; and
wherein the plurality of signal control wires comprise a power line and signal lines having a remote control function and a plug-and-play function.

2. The HDMI photoelectric composite cable according to claim 1, wherein the optical fiber unit is arranged in a center of the HDMI photoelectric composite cable, and the plurality of signal control wires and the ground wire are arranged on the periphery of the optical fiber unit.

3. The HDMI photoelectric composite cable according to claim 1, wherein the optical fiber unit comprises four optical fibers, each of which is a colored multimode optical fiber or a fiber ribbon.

4. The HDMI photoelectric composite cable according to claim 1, wherein the optical fiber sheath is flame-retardant polyvinyl chloride, polyethylene, cross-linked polyethylene or fluorinated ethylene propylene.

5. The HDMI photoelectric composite cable according to claim 1, wherein the metal wire is a single strand of tin-plated copper, a single strand of bare copper, a single strand of silver-plated copper, twisted tin-plated copper wires, twisted bare copper wires, or twisted silver-plated copper wires.

6. The HDMI photoelectric composite cable according to claim 1, wherein the insulating layer is foamed polyethylene, polyvinyl chloride, polyethylene, cross-linked polyethylene or fluorinated ethylene propylene.

7. The HDMI photoelectric composite cable according to claim 1, wherein the fillers are aramid yarns, PP ripcords, cotton yarns or nylon yarns.

8. The HDMI photoelectric composite cable according to claim 1, wherein the shielding layer is a polyester tape, an aluminum foil, a copper foil polyethylene terephthalate tape, cotton paper or a polytetrafluoroethylene tape.

9. The HDMI photoelectric composite cable according to claim 1, wherein the sheath is polyvinyl chloride, low-smoke halogen-free flame-retardant polyolefin, a nylon elastomer, a polyurethane elastomer or a cross-linked polyethylene elastomer.

10. A method for manufacturing the HDMI photoelectric composite cable according to claim 1, comprising:
providing a plurality of signal control wires comprising a power line and signal lines having a remote control function and a plug-and-play function, a ground wire and a plurality of optical fibers, each of the signal control wires comprising a metal wire and an insulating layer uniformly extruded on a periphery of the metal wire, wherein material of the insulating layer is a material having a low dielectric constant to reduce capacitance of the HDMI photoelectric composite cable;
extruding an optical fiber sheath on a periphery of the plurality of optical fibers uniformly by an extruder, and forming an optical fiber unit;
twisting the optical fiber unit, the plurality of signal control wires and the ground wire concentrically and unidirectionally to form a stranded conductor, and uniformly covering a periphery of the stranded conductor by the fillers;
extruding a shielding layer on the periphery of the fillers; and
extruding a sheath on the periphery of the shielding layer.
